(19) United States
(12) Patent Application Publication
(10) Pub. No.: US 2013/0110451 A1
(43) Pub. Date: May 2, 2013

(54) STATE ESTIMATION APPARATUS

(71) Applicant: Yamaha Corporation, Hamamatsu-Shi (JP)

(72) Inventor: Ibuki Handa, Hamamatsu-shi (JP)

(73) Assignee: Yamaha Corporation, Hatmamatsu-Shi (JP)

(21) Appl. No.: 13/661,244

(22) Filed: Oct. 26, 2012

(30) Foreign Application Priority Data
Oct. 28, 2011 (JP) 2011-237045

(51) Int. Cl. G01P 15/18; G06F 15/00

(52) U.S. Cl. 702/141

(57) ABSTRACT

A state estimation apparatus is mounted in a portable instrument having a part generating a magnetic field. The state estimation apparatus is provided with a magnetic sensor and an acceleration sensor. A stability decision module decides whether motion of the portable instrument is stable or not. A Kalman filter operation module sets an initial vector to a state vector of Kalman filter as an initial value thereof in case that the stability decision module decides that the motion of the portable instrument is stable, and then updates the state vector using an observed value vector having outputs the magnetic sensor and the acceleration sensor, the initial vector having as components thereof an estimated value of an offset representing the magnetic field generated by the part of the instrument and a vector estimating a posture of the portable instrument.

### BACKGROUND OF THE INVENTION

1. Technical Field of the Invention

The present invention relates to a state estimation apparatus.

2. Description of the Related Art

In a case in which the direction of geomagnetism and the posture of an object are calculated, it is possible to obtain a correct value for a shorter period of time through calculation by consolidating output results from a plurality of sensors, such as an acceleration sensor and an angular velocity sensor, for measuring different kinds of physical quantities in addition to a geomagnetic sensor than simple calculation only based on the output result from the geomagnetic sensor.

A method using a nonlinear Kalman filter is well known as a method of consolidating outputs from a plurality of sensors for measuring different kinds of physical quantities to estimate the state of a dynamic system. For example, patent literature 1 discloses a posture angle measuring apparatus having a three axis angular velocity sensor, a three axis acceleration sensor, and a nonlinear Kalman filter mounted therein. Also, non-patent literature 1 discloses a method of consolidating signals output from a three axis angular velocity sensor, a three axis acceleration sensor, and a three axis geomagnetic sensor using an extended Kalman filter or a sigma point Kalman filter using unscented transformation to estimate the posture.

Generally, a nonlinear Kalman filter has a state transition model for estimating time-based change of a plurality of physical quantities representing the state of a dynamic system and an observation model for estimating a value (observed value) measured by a plurality of sensors of the dynamic system from the estimated state of the dynamic system. Also, the nonlinear Kalman filter successively updates a state vector having values as its components (hereafter, state variables) estimating a plurality of physical quantities representing the state of the dynamic system using difference between the estimated observed value and an observed value actually measured by the plurality of sensors (hereafter, observation residual) to perform an operation so that the values indicated by the respective components of the state vector approximate to actual physical quantities (hereafter, true values).
[Patent Literature 1] Japanese Patent Application Publication No. H9-5104
[Non-Patent Literature 1] Wolfgang Gunthner, “Enhancing Cognitive Assistance Systems with Inertial Measurement Units”, Springer, 2008, page 49-77

However, the nonlinear Kalman filter performs an operation of successively updating the state vector using the state vector and the observation residual calculated based on the state vector. For this reason, in a case in which initial values of components of the state vector is set to values deviating from true values, it may take a long time until the respective components of the state vector converge to values approximate to the true values. Furthermore, the respective components of the state vector may converge to incorrect values different from the true values.

### SUMMARY OF THE INVENTION

The present invention has been made in view of the above problems, and it is an object of the present invention to rapidly and correctly estimate the direction of geomagnetism and the posture of an object by calculating an initial value of a state vector having a value approximate to a true value and y performing a nonlinear Kalman filter operation to update the state vector.

In order to solve the above problems, the present invention provides a state estimation apparatus mounted in an instrument comprising a part generating a magnetic field, the state estimation apparatus comprising: a three-dimensional magnetic sensor that detects magnetic components in three directions perpendicular to each other and sequentially outputs magnetic data as three-dimensional vector data expressed in a three axis coordinate system; a three-dimensional acceleration sensor that detects acceleration at three axes perpendicular to each other and sequentially outputs acceleration data as three-dimensional vector data expressed in a three axis coordinate system; a stability decision module that decides whether motion of the instrument is stable or not; and a Kalman filter operation module that sets an initial vector to a state vector of Kalman filter as an initial value thereof in case that the stability decision module decides that the motion of the instrument is stable, and then updates the state vector of Kalman filter using an observed value vector having outputs of a plurality of sensors being mounted in the instrument and including the three-dimensional magnetic sensor and the three-dimensional acceleration sensor, the initial vector having as components thereof an estimated value of an offset representing the magnetic field generated by the part of the instrument and a vector estimating a posture of the instrument.

Preferably, the state estimation apparatus further comprises an initial vector generation module that generates the initial vector in case that the stability decision module decides that the motion of the instrument is stable.

Preferably, the initial vector generation module generates the initial vector based on the magnetic data, the acceleration data, and three axis coordinates of a central point of a plurality of magnetic data, the central point indicating an approximate value of the offset of the three-dimensional magnetic sensor.

Preferably, the state estimation apparatus further comprises an accumulation module that accumulates the magnetic data sequentially output from the three-dimensional magnetic sensor; and a central point calculation module that calculates the three axis coordinates of the central point based on the plurality of magnetic data accumulated in the accumulation module.

Preferably, the stability decision module decides whether the motion of the instrument is stable or not based on the plurality of acceleration data output from the three dimensional acceleration sensor.

In the Kalman filter operation, in a case in which the initial values of the state vector (namely, initial vector) deviates from a true value, it takes a long time until each component of the state vector converges to a value approximate to the true value.

According to this invention, the offset estimation value of the three-dimensional magnetic sensor set based on the coordinates of the central point calculated by the central point calculation module and the estimated value of the posture calculated based on the magnetic data and the acceleration data when it is decided that the motion of the instrument is stable are set as components of the initial vector.

Since the coordinates of the central point calculated by the central point calculation module are coordinates indicating an approximate value of the offset of the three-dimensional magnetic sensor, it is possible to set the offset estimation value to a value approximate to the true value. In addition, it is possible to obtain a correct direction of the geomagnetism using the offset estimation value of the three-dimensional magnetic sensor and the magnetic data.

Also, since it is possible to obtain the direction of the acceleration of gravity from the acceleration data when the motion of the instrument is stable, it is possible to calculate an estimated value of the posture approximate to a true value based on the direction of the acceleration of gravity and the direction of the geomagnetism.

That is, according to this invention, it is possible to set each component of the initial vector to a value approximate to a true value, and therefore, it is possible to rapidly converge each components of the state vector to a value approximate to a true value in the Kalman filter operation.

Also, the state estimation apparatus may further comprise a first notification part that urges a user to change the posture of the instrument before the central point calculation module starts to acquire the plurality of magnetic data used to calculate the central point.

The three-dimensional magnetic sensor detects geomagnetism and a magnetic field generated by the part. In a case in which the posture of the three-dimensional magnetic sensor is changed, the geomagnetism is detected as a magnetic field, the magnitude of which is uniform but the direction of which is changed. On the other hand, the magnetic field generated by the part of the instrument is detected as a magnetic field having a uniform direction and magnitude no matter how the posture of the three-dimensional magnetic sensor is changed. Consequently, the coordinates indicated by a plurality of magnetic data detected while three-dimensionally changing the posture of the three-dimensional magnetic sensor in the coordinate system fixed to the three-dimensional magnetic sensor are distributed in the vicinity of a spherical surface having the coordinates indicated by the vector representing the magnetic field generated by the part of the instrument as a central point and the magnitude of the geomagnetism as a radius. Also, the coordinates of the central point of the spherical surface represent an approximate value of the offset of the three-dimensional magnetic sensor.

In order to calculate the approximate value of the offset based on a plurality of magnetic data, therefore, it is necessary to uniquely specify a spherical surface having the coordinates indicated by a plurality of magnetic data in the vicinity thereof. To this end, it is necessary for the coordinates indicated by a plurality of magnetic data to be distributed with three-dimensional spread without being two-dimensionally distributed.

According to this invention, the first notification part for urging the user to change the posture of the instrument is provided, and therefore, it is expected for the user to three-dimensionally change the posture of the instrument in acquiring a plurality of magnetic data. The coordinates indicated by a plurality of magnetic data acquired while three-dimensionally changing the posture of the instrument are distributed with three-dimensional spread. Consequently, it is possible to uniquely specify a spherical surface having the coordinates indicated by a plurality of magnetic data in the vicinity thereof, and therefore, it is possible to calculate the coordinates of a central point indicating an approximate value of the offset of the three-dimensional magnetic sensor.

Also, the state estimation apparatus may further comprise a second notification part for urging the user not to change the posture of the instrument after the central point calculation module calculates the central point.

According to this invention, the second notification part is provided for urging the user not to change the posture of the instrument, and therefore, it is expected for the user to hold the portable instrument in a stable state in which the instrument is not moved.

In a case in which the motion of the instrument is stable, it is possible to obtain the direction of the acceleration of gravity from the acceleration data, and therefore, it is possible to obtain an estimated value of the posture approximate to a true value based on the direction of the acceleration of gravity and the direction of the geomagnetism.

Also, the stability decision module of the state estimation apparatus may comprise a low pass filter for calculating reference acceleration data based on the plurality of acceleration data, then calculate stability indices representing errors between three axis coordinates indicated by the acceleration data and three axis coordinates indicated by the reference acceleration data with respect to a predetermined number of the acceleration data, and may decide that the motion of the instrument is stable in case that all of the stability indices are equal to or less than a first threshold value.

According to this invention, a predetermined number of stability indices representing errors between reference acceleration data obtained by having the acceleration data pass through the low pass filter and a predetermined number of acceleration data are calculated to decide whether the predetermined number of acceleration data indicate an almost uniform value.

When fluctuation of values indicated by the plurality of acceleration data is small, and the values are almost uniform, it is possible to assume the acceleration data as indicating the acceleration of gravity except for, for example, a special case in which the instrument is in constant acceleration movement. According to this embodiment, therefore, it is possible to decide whether it is possible to calculate the direction of the acceleration of gravity from the acceleration data and, in a case in which the decision result is affirmative, to obtain an estimated value of the posture approximate to a true value based on the direction of the acceleration of gravity calculated from the acceleration data and the direction of the geomagnetism.

Also, the stability decision module of the state estimation apparatus may calculate a variance of the three axis coordinates indicated by a predetermined number of the acceleration data as a stability index, and decides that the motion of the instrument is stable in case that the stability index is equal to or less than a second threshold value.

According to this invention, a stability index representing a variance of the three axis coordinates indicated by a predetermined number of the acceleration data is calculated, and it is decided whether the predetermined number of acceleration data indicates an almost uniform value. According to this invention, therefore, it is possible to decide whether the direction of the acceleration of gravity can be calculated from the acceleration data, and in a case in which the decision result is affirmative, it is possible to obtain an estimated value of the posture approximate to a true value based on the direction of the acceleration of gravity calculated from the acceleration data and the direction of the geomagnetism.

The invention further includes a control method of a state estimation apparatus mounted in an instrument comprising a part generating a magnetic field, the state estimation apparatus including a three-dimensional magnetic sensor that detects magnetic components in three directions perpendicular to each other and sequentially outputs magnetic data as three-dimensional vector data expressed in a three axis coordinate system, and a three-dimensional acceleration sensor that detects acceleration at three axes perpendicular to each other and sequentially outputs acceleration data as three-dimensional vector data expressed in a three axis coordinate system, the control method comprising: a stability decision step of deciding whether motion of the instrument is stable or not; and a Kalman filter operation step of setting an initial vector to a state vector of Kalman filter as an initial value thereof in case that the stability decision step decides that the motion of the instrument is stable, and then updating the state vector of Kalman filter using an observed value vector having outputs of a plurality of sensors being mounted in the instrument and including the three-dimensional magnetic sensor and the three-dimensional acceleration sensor, the initial vector having as components thereof an estimated value of an offset representing the magnetic field generated by the part of the instrument and a vector estimating a posture of the instrument.

### BRIEF DESCRIPTION OF THE DRAWINGS

FIG. 1 is a block diagram showing the construction of a portable instrument according to an embodiment of the present invention.

FIG. 2 is a perspective view showing the external appearance of the portable instrument.

FIGS. 3(A) and 3(B) are a conceptual view illustrating the outline of a magnetic field detected by a three-dimensional magnetic sensor according to an embodiment of the present invention.

FIG. 4 is a flow chart showing the process flow of a state estimation program according to an embodiment of the present invention.

FIG. 5 is a functional block diagram showing a function realized by executing a stability decision module according to an embodiment of the present invention.

FIG. 6 is a functional block diagram showing a function realized by executing a Kalman filter module according to an embodiment of the present invention.

### DETAILED DESCRIPTION OF THE INVENTION

### A. Embodiments

Hereinafter, an embodiment of the present invention will be described with reference to the accompanying drawings.

### 1. Construction of Instrument and Construction of Software

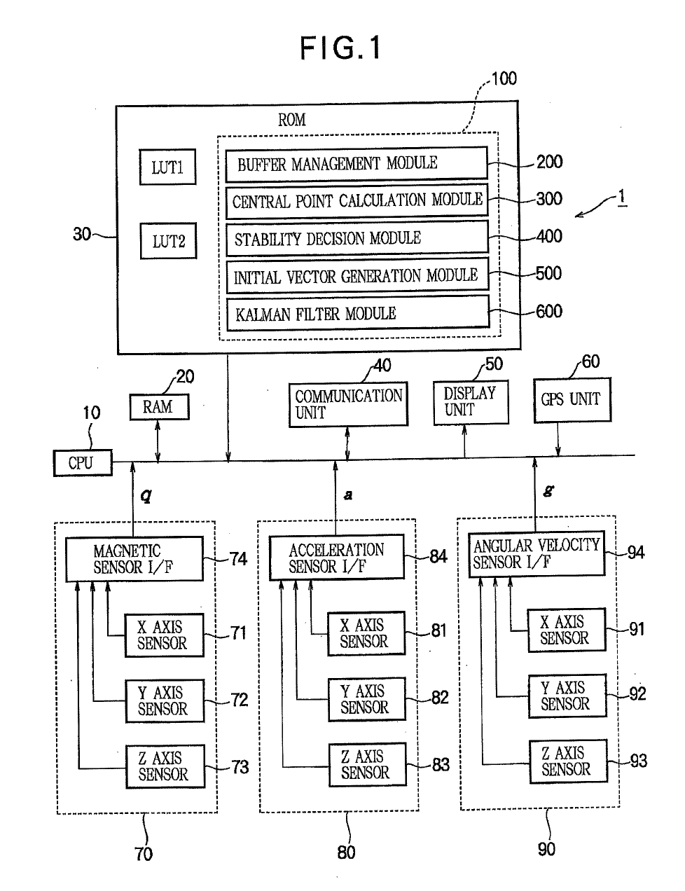

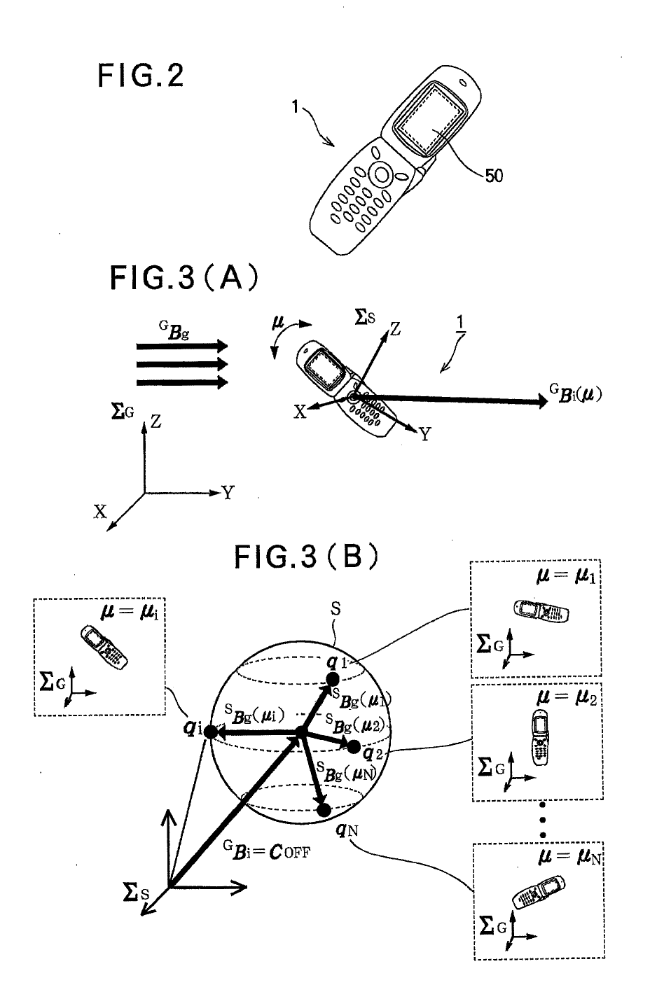

FIG. 1 is a block diagram of a portable instrument according to an embodiment of the present invention, and FIG. 2 is a perspective view showing the external appearance of the portable instrument. The portable instrument 1 has a function to rotate a displayed picture, such as a map, in response to the posture of a screen so that azimuth displayed by the picture follows that of a real space. This function is realized by performing a Kalman filter operation based on outputs from various sensors to estimate the posture of the portable instrument 1 and the direction of geomagnetism B_{g} when viewed from the portable instrument 1.

The portable instrument 1 includes a CPU 10 connected to various kinds of constructional elements via buses for controlling the entirety of the apparatus, a RAM (accumulation unit) 20 functioning as a work area of the CPU 10, a ROM 30 for storing various kinds of programs, such as a state estimation program 100, and data, a communication unit 40 for performing communication, a display unit 50 for displaying a picture, and a GPS unit 60.

Also, the portable instrument 1 includes a three-dimensional magnetic sensor 70 for detecting magnetism, such as geomagnetism B_{g}, to output magnetic data, a three-dimensional acceleration sensor 80 for detecting acceleration to output acceleration data, and a three-dimensional angular velocity sensor 90 for detecting angular velocity to output angular velocity data.

Using a picture such an arrow, the display unit 50 displays the direction of geomagnetism B_{g} and the posture μ of the portable instrument 1 calculated based on the state of a system estimated by the CPU 10 executing the state estimation program 100.

The GPS unit 60 receives a signal from a GPS satellite to generate position information (latitude and longitude) of the portable instrument 1.

The three-dimensional magnetic sensor 70 includes an X axis magnetic sensor 71, a Y axis magnetic sensor 72, and a Z axis magnetic sensor 73. Each of the sensors can be configured using a magnetic impedance device (MI device) or a magnetic resistance effect device (MR device). A magnetic sensor I/F 74 converts analog output signals from the respective sensors into digital signals to output magnetic data q. The magnetic data q are vector data represented by x axis, y axis, and z axis components.

Meanwhile, the portable instrument 1, in which the three-dimensional magnetic sensor 70 is mounted, occasionally includes a mechanical or electrical part generating a magnetic field, such as various kinds of metal that can be magnetized and electric circuits. For this reason, the vector data (magnetic data q) output by the three-dimensional magnetic sensor 70 also include a vector representing a magnetic field (internal magnetic field Bᵢ) generated by the part mounted in the portable instrument 1 in addition to a vector representing geomagnetism B_{g}. In order to correctly detect the direction of the geomagnetism B_{g}, therefore, it is necessary to perform a correction process for removing the vector representing the internal magnetic field Bᵢ generated by the part of the portable instrument 1 from the vector data (magnetic data q) output by the three-dimensional magnetic sensor.

As a premise for describing the correction process, first, properties of the geomagnetism B_{g} and the internal magnetic field Bᵢ will be described.

As shown in FIG. 3(A), the geomagnetism B_{g} is a magnetic field having a horizontal component directed to a north magnetic pole and a component perpendicular to a magnetic dip direction. The geomagnetism B_{g} is represented as a vector ^{G}B_{g} having a uniform direction and magnitude in a ground coordinate system Σ_{G}, which is a coordinate system fixed to the ground. On the other hand, the internal magnetic field Bᵢ is a magnetic field generated by the mechanical or electrical part of the portable instrument 1. The internal magnetic field Bᵢ has a uniform direction with respect to the portable instrument 1 and uniform magnitude. That is, the internal magnetic field Bᵢ is represented as a vector ^{G}Bᵢ(μ), the direction of which is changed according to the change in posture μ of the portable instrument 1 and the magnitude of which is uniform in the ground coordinate system Σ_{G}.

Here, a sensor coordinate system Σ_{S}, which is a coordinate system fixed to the portable instrument 1 (strictly speaking, fixed to the three-dimensional magnetic sensor 70) is introduced to express magnetic data q as coordinates on the sensor coordinate system Σ_{S}. More specifically, of the coordinates on the sensor coordinate system Σ_{S} indicated by the magnetic data q, an x axis component is a value output from the X axis magnetic sensor 71, a y axis component is a value output from the Y axis magnetic sensor 72, and a z axis component is a value output from the Z axis magnetic sensor 73.

When viewed from the sensor coordinate system Σ_{S} as described above, the geomagnetism B_{g} is represented as a vector ^{S}B_{g}(μ), the direction of which is changed according to the posture μ of the portable instrument 1 and the magnitude of which is uniform, and the internal magnetic field Bᵢ is represented as a vector ^{S}Bᵢ having a uniform direction and magnitude.

Consequently, a plurality of magnetic data q₁ to q_{N} acquired while changing the posture μ of the portable instrument 1, when viewed from the ground coordinate system Σ_{G}, from μ₁ to μ_{N}, is distributed on a spherical surface S having the coordinates of the vector ^{S}Bᵢ representing the internal magnetic field Bᵢ as the center and having the magnitude of the geomagnetism B_{g} as the radius in the sensor coordinate system Σ_{S}, as shown in FIG. 3(B). Also, the direction of the geomagnetism B_{g} in sensor coordinate system Σ_{S} is specified by subtracting the coordinates indicated by the vector ^{S}Bᵢ representing the internal magnetic field Bᵢ from the coordinates indicated by the magnetic data q.

The vector representing the internal magnetic field Bᵢ is referred to as an offset of the magnetic sensor C_{OFF}. This offset is subtracted from the magnetic data q output from the three-dimensional magnetic sensor 70 in the correction process to specify a correct direction of the geomagnetism B_{g} to be detected as described above.

Meanwhile, when considering a measurement error of the three-dimensional magnetic sensor 70, the coordinates indicated by the magnetic data q₁ to q_{N} are not distributed on the spherical surface S but are distributed in the vicinity of the spherical surface S. Consequently, the coordinates of a central point c_{S} of the spherical surface S having the coordinates indicated by the magnetic data q₁ to q_{N} in the vicinity thereof become an approximate value of the coordinates indicated by the vector ^{S}Bᵢ representing the internal magnetic field Bᵢ (that is, an approximate value of the offset c_{OFF}).

Referring back to FIG. 1, the three-dimensional acceleration sensor 80 includes an X axis acceleration sensor 81, a Y axis acceleration sensor 82, and a Z axis acceleration sensor 83. Each of the sensors may be a piezo resistance type sensor, a capacitive type sensor, or a heat detection type sensor. An acceleration sensor I/F 84 converts analog output signals from the respective sensors into digital signals to output acceleration data a. The acceleration data a are data representing resultant force of inertial force and gravity in a coordinate system fixed to the portable instrument 1, with which the three-dimensional acceleration sensor 80 is formed integrally so that the three-dimensional acceleration sensor 80 operates simultaneously with the portable instrument 1. The acceleration data a is a vector having x axis, y axis, and z axis components. When the portable instrument 1 is in a stationary state or in a uniform linear motion, therefore, the acceleration data a become vector data indicating the magnitude and direction of the acceleration of gravity in the coordinate system fixed to the portable instrument 1.

The three-dimensional angular velocity sensor 90 includes an X axis angular velocity sensor 91, a Y axis angular velocity sensor 92, and a Z axis angular velocity sensor 93. An angular velocity sensor I/F 94 converts analog output signals from the respective sensors into digital signals to output angular velocity data g. The angular velocity data g are vector data indicating rotational angular velocity of the respective axes.

The CPU 10 executes a state estimation program 100 stored in the ROM 30 to estimate a plurality of physical quantities, such as the posture of the portable instrument 1 and the offset of the magnetic sensor, representing the state of the system. That is, the CPU 10 executes the state estimation program 100, and therefore, the portable instrument 1 functions as a state estimation apparatus.

The state estimation program 100 includes a module group, such as a buffer management module 200, a central point calculation module 300, a stability decision module 400, an initial vector generation module 500, and a Kalman filter module 600.

The buffer management module 200 accumulates magnetic data q sequentially output from the three-dimensional magnetic sensor 70 in a buffer. The RAM 20 is used as a buffer of an accumulation module for accumulating the magnetic data.

The central point calculation module 300 calculates the coordinates of the central point c_{S} of the spherical surface S having the coordinates indicated by the magnetic data q₁ to q_{q} in the vicinity thereof in the sensor coordinate system Σ_{S} based on a plurality of magnetic data q₁ to q_{N} accumulated in the RAM 20.

The stability decision module 400 decides whether the motion of the portable instrument 1 is stable or not based on the acceleration data a output from the three-dimensional acceleration sensor 80.

The initial vector generation module 500 generates an initial vector INI in a case in which the decision result of the stability decision module 400 is affirmative.

The Kalman filter module 600 executes an operation of updating a state vector x having the initial vector INI as an initial value thereof based on an observed value vector y (a nonlinear Kalman filter operation) to estimate the state of the system.

Here, the state vector x is a vector having a plurality of state variables as components. The respective state variables, which are components of the state vector x, represent a plurality of physical quantities indicating the state of the system estimated by the nonlinear Kalman filter. That is, the state vector x is a vector representing the state of the system estimated by the nonlinear Kalman filter.

In this embodiment, the posture μ of the portable instrument 1, magnitude r of the geomagnetism, a magnetic dip φ of the geomagnetism, angular velocity ω of the portable instrument 1, offset estimation values b_{O} of the angular velocity sensors 91 to 93, and offset estimation values c_{O} of the magnetic sensors 71 to 73 are adopted as components (state variables) of the state vector x, and these components are estimated.

A state vector xₖ at time T=k is represented by the following equation (1). Meanwhile, a subscript k attached to the right lower part of each of the state variables indicates that each of the state variables is a value at time T=k.

$${x}_{k} = [ \begin{matrix}{μ}_{k} \\ {r}_{k} \\ {φ}_{k} \\ {ω}_{k} \\ {b}_{O , k} \\ {c}_{O , k}\end{matrix} ] \qquad ( 1 )$$

Here, the magnitude r of the geomagnetism is a scalar, the magnetic dip φ of the geomagnetism is a scalar, the angular velocity ω is a vector, the offset estimation values b_{O} of the angular velocity sensors are a three-dimensional vector, and the offset estimation values c_{O} of the magnetic sensors are a three-dimensional vector.

Also, the posture μ is expressed using a quaternion. The quaternion is a four-dimensional number representing the posture (rotational state) of an object. For example, the posture μ when the respective axes of the sensor coordinate system Σ_{S} coincide with the respective axes of the ground coordinate system Σ_{G} is defined as a reference posture, and the reference posture is expressed as μ=(0, 0, 0, 1). At this time, an arbitrary posture μ of the portable instrument 1 can be expressed as a posture when the portable instrument 1 is rotated by an angle ψ in the direction of a unit vector ρ as a rotational axis with respect to the reference posture. A posture μ after rotation is represented by equation (2) using the quaternion.

$$\begin{matrix}μ = [ \begin{matrix}{μ}_{1} \\ {μ}_{2} \\ {μ}_{3} \\ {μ}_{4}\end{matrix} ] \\ = [ \begin{matrix}ρ sin ( \frac{ψ}{2} ) \\ cos ( \frac{ψ}{2} )\end{matrix} ]\end{matrix} \qquad ( 2 )$$

The observed value vector y has, as its components, magnetic data q output from the three-dimensional magnetic sensor 70, acceleration data a output from the three-dimensional axis acceleration sensor 80, and angular velocity data g output from the three-dimensional axis angular velocity sensor 90.

An observed value vector yₖ at time T=k is represented by equation (3).

$${y}_{k} = [ \begin{matrix}{q}_{k} \\ {a}_{k} \\ {g}_{k}\end{matrix} ] \qquad ( 3 )$$

Meanwhile, the nonlinear Kalman filter operation is an operation of periodically updating the state vector using an observation residual calculated based on the state vector and the observed value vector. In a case in which an initial value set to the state vector deviates from a true value, therefore, it may take a long time to converge each component of the state vector to a value approximate to the true value.

Also, the nonlinear Kalman filter operation is a nonlinear operation. In a case in which the initial value set to the state vector greatly deviates from the true value, therefore, each component of the state vector may not converge to the true value (or a value approximate to the true value) but may converge to a value different from the true value although the state vector is repeatedly updated.

In the nonlinear Kalman filter operation, therefore, it is necessary to set each initial value of the state vector x (that is, the initial vector INI) to a value approximate to the true value in order to correctly and rapidly estimate the state of the system.

Here, the ‘true value’ is a value representing a real physical quantity corresponding to each component of the state vector xₖ. Also, the ‘true value of the state vector’ is a vector when the vector has each component of the state vector xₖ as a true value.

### 2. Process Flow of State Estimation Apparatus

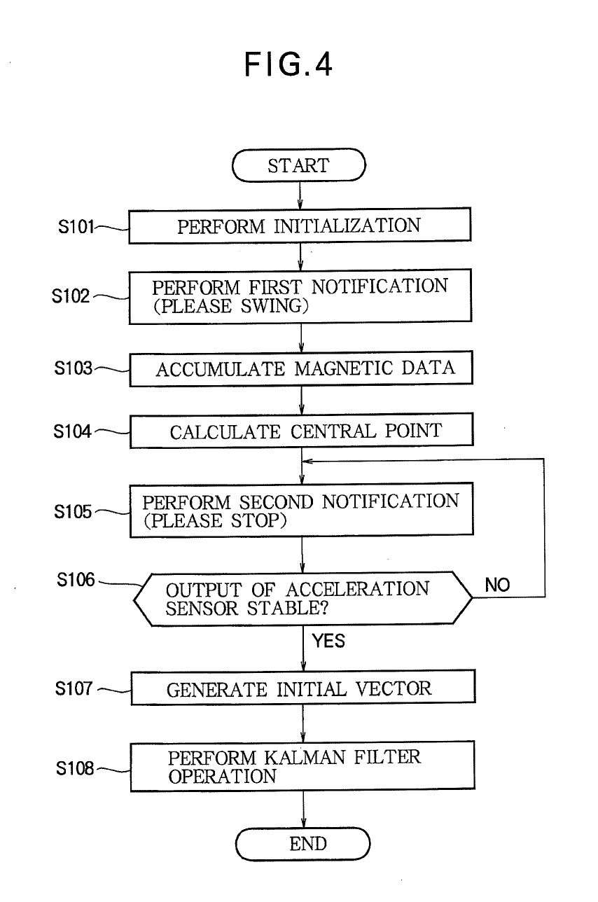

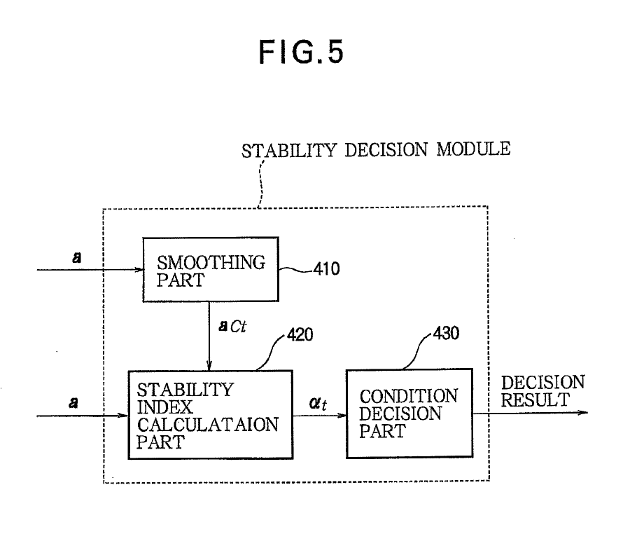

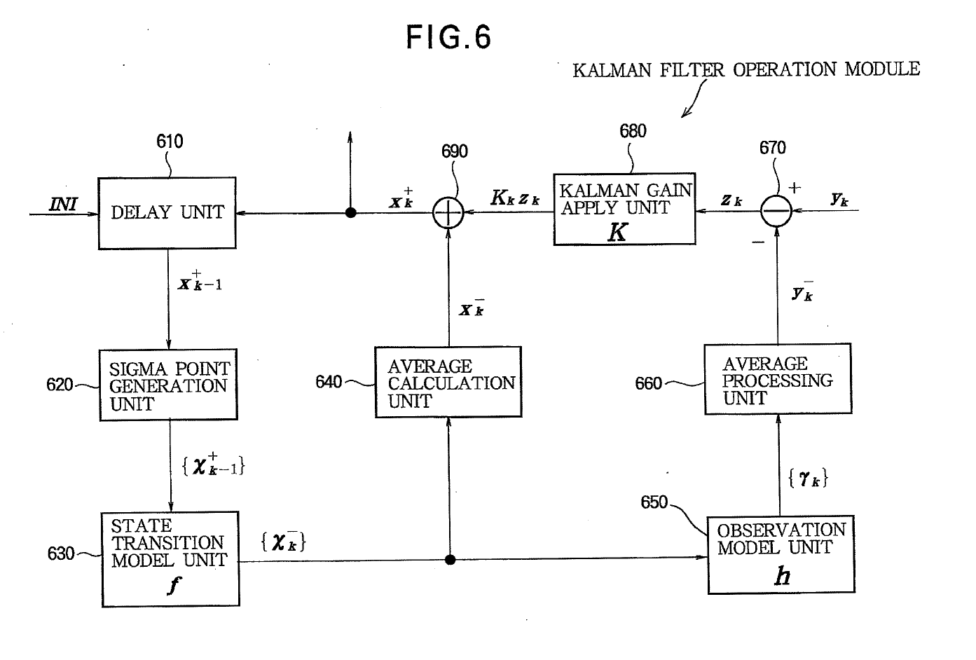

FIG. 4 is a flow chart showing the process flow of the state estimation program 100 executed by the CPU 10. Hereinafter, the process flow when the state estimation program 100 is executed by the CPU 10 will be described with reference to FIGS. 5 and 6, which illustrate functions realized when the respective steps of the flow chart are executed in detail, in addition to FIG. 4.

First, at step S101, the CPU 10 performs an initialization process. Specifically, the CPU 10 calls the buffer management module 200 to delete all magnetic data q stored in the RAM 20. Meanwhile, although, in this embodiment, the CPU 10 deletes all of the magnetic data q, the CPU 10 may delete only a predetermined earlier portion of the magnetic data accumulated in the RAM 20.

At step 102, the CPU 10 performs a first notification. Specifically, the CPU 10 instructs a user of the portable instrument 1 to three-dimensionally change the posture of the portable instrument 1 by displaying a still picture or a motion picture on the display unit 50. That is, the CPU 10 functions as a first notification part by performing the first notification of step S102.

Meanwhile, although, in this embodiment, the CPU 10 performs the first notification by displaying a still picture or a motion picture using the display unit 50, the CPU 10 may perform the first notification using voice guide.

At step S103, the CPU 10 performs a magnetic data accumulation process. Specifically, the CPU 10 calls the buffer management module 200 to store N magnetic data q₁ to q_{N} sequentially output from the three-dimensional magnetic sensor 70 in the RAM 20 (Here, N being a natural number, equal to or greater than 5, indicating a prescribed number of times for measuring magnetic data necessary to derive the central point c_{S} at high precision in a central point calculation process, which will be described below). That is, the CPU 10 functions as an accumulation module by performing the magnetic data accumulation process of step S103.

Next, at step S104, the CPU 10 performs a central point calculation process. Specifically, the CPU 10 calls the central point calculation module 300 to calculate the coordinates of the central point c_{S} of the spherical surface S having the coordinates indicated by the magnetic data q₁ to q_{N} accumulated in the RAM 20 in the vicinity thereof. That is, the CPU 10 functions as a central point calculation module by performing the central point calculation process of step S104.

Meanwhile, as previously described, the vector indicating the coordinates of the central point c_{S} is a value approximate to the offset c_{OFF}. The coordinates of the central point c_{S} may be calculated properly using a well known method. For example, the coordinates of the central point c_{S} may be calculated using a method disclosed in Japanese Patent Application Publication No. 2007-240270, filed in the name of applicant of this case.

Next, at step S105, the CPU performs a second notification. Specifically, the CPU instructs a user of the portable instrument 1 not to move the portable instrument 1 by displaying a still picture or a motion picture on the display unit 50. That is, the CPU 10 functions as a second notification part by performing the second notification of step S105.

Meanwhile, although, in this embodiment, the CPU 10 performs the second notification by displaying a still picture or a motion picture using the display unit 50, the CPU 10 may perform the second notification using voice guide.

Subsequently, at step S106, the CPU 10 performs a stability decision process. Specifically, the CPU 10 calls the stability decision module 400 to decide whether the motion of the portable instrument 1 is stable or not based on the acceleration data a output from the three-dimensional acceleration sensor 80. That is, the CPU 10 functions as a stability decision module by performing the stability decision process of step S106.

FIG. 5 is a functional block diagram showing a function of the stability decision module realized by the CPU 10 executing the stability decision process of step S106.

As shown in FIG. 5, the stability decision module includes a smoothing part 410, a stability index calculation part 420, and a condition decision part 430.

The smoothing part 410 smoothes the respective components of the acceleration data a sequentially output from the three-dimensional acceleration sensor 80 through a low pass filter to calculate reference acceleration data a_{C}.

Here, a well known filter may be properly used as the low pass filter. For example, a finite impulse response (FIR) filter or an infinite impulse response (IIR) filter may be used as the low pass filter.

Meanwhile, although, in this embodiment, starting to input the acceleration data a to the smoothing part 410 is timing for the CPU 10 to start the stability decision process of step S106, input may be started at different timing. For example, at the timing when the CPU 10 starts the initialization process of step S101, the acceleration data a may start to be input to the smoothing part 410. In this case, the CPU 10 starts the stability decision process of step S106 at the timing to start the initialization process of step S101 so that the smoothing part 410 functions.

Next, the stability index calculation part 420 calculates a stability index a based on the acceleration data a output from the three-dimensional acceleration sensor 80 and the reference acceleration data a_{C} output from the smoothing part 410.

A stability index αₜ calculated at time t is represented by the following equation (4a). Meanwhile, acceleration data aₜ represented by equation (4b) are acceleration data at time t, and reference acceleration data a_{Ct} represented by equation (4c) are reference acceleration data at time t.

αₜ=∥αₜ−α_{Ct}∥₂² (4a)

where αₜ=[αₓₜ α_{yt} α_{zt}]^{T} (4b)

α_{Ct}=[α_{Cxt} α_{Cyt} α_{Czt}]^{T} (4c)

The stability index calculation part 420 calculates M stability indices αₜ (t=1, . . . , M) during a period from time t=1 to time t=M.

Here, M is an arbitrary natural number equal to or greater than 1. Meanwhile, in a case in which it is necessary to more exactly decide whether the motion of the portable instrument 1 is stable, M may be set to as large a natural number as possible.

The condition decision part 430 decides whether all of the M stability indices αₜ (t=1, . . . , M) are equal to or less than a first threshold value α_{TH} as represented by the following equation (5).

αₜ≦α_{TH} (t=1, . . . , M) (5)

Referring back to FIG. 4, the CPU performs the stability decision process of step S106 first to calculate the M stability indices αₜ and then to decide whether all of the M stability indices αₜ are equal to or less than the first threshold value α_{TH}. In a case in which the decision result of the stability decision process is affirmative, the CPU 10 advances the process to step S107. In a case in which the decision result of the stability decision process is negative, on the other hand, the CPU 10 returns the process to step S105.

Next, at step S107, the CPU 10 performs an initial vector generation process. Specifically, the CPU 10 calls the initial vector generation module 500 to generate an initial vector INI based on the magnetic data q output from the three-dimensional magnetic sensor 70 at time t=M (that is, at the timing when the decision result of the condition decision part 430 is affirmative), the acceleration data a output from the three-dimensional acceleration sensor 80 at time t=M, and the coordinates of the central point c_{S} calculated at step S104. That is, the CPU 10 functions as an initial vector generation module by performing the initial vector generation process of step S107.

As previously described, the initial vector INI is an initial value of the state vector xₖ, i.e. a state vector x₀ at time T=0. The initial vector INI includes an initial value μ₀ of the posture μ, an initial value r₀ of the magnitude r of the geomagnetism, an initial value φ₀ of the magnetic dip φ of the geomagnetism, an initial value ω₀ of the angular velocity ω, an initial value b_{O,0} of the offset estimation value b_{O} of the angular velocity sensor, and an initial value c_{O,0} of the offset estimation value c_{O} of the magnetic sensor as the components. The initial vector INI is represented by the following equation (6). Meanwhile, hereinafter, timing when the CPU 10 generates the initial vector INI by performing the initial vector generation process is expressed as time T=0. Time T=0 is equal to time t=M.

$$I N I = [ \begin{matrix}{μ}_{0} \\ {r}_{0} \\ {φ}_{0} \\ {ω}_{0} \\ {b}_{O , 0} \\ {c}_{O , 0}\end{matrix} ] \qquad ( 6 )$$

Hereinafter, a method of generating the initial vector INI will be described in detail.

First, magnetic data q₀ output by the three-dimensional magnetic sensor 70 at time T=0 are represented by the following equation (7) using the vector ^{G}B_{g} representing the geomagnetism B_{g} from the ground coordinate system Σ_{G} and the initial value c_{O,0} of the offset estimation value c_{O} of the three-dimensional magnetic sensor 70.

Here, in a case in which the portable instrument 1 assumes the posture μ, a matrix B(μ) is a coordinate conversion matrix for converting a vector expressed in the ground coordinate system Σ_{G} so that the vector can be expressed in the sensor coordinate system Σ_{S}. The matrix B(μ) is represented by the following equation (8). Also, the vector ^{G}B_{g} representing the geomagnetism B_{g} at time T=0 from the ground coordinate system Σ_{G} is represented by the following equation (9) using the initial value r₀ of the magnitude r of the geomagnetism and the initial value (1)₀ of the magnetic dip φ of the geomagnetism. Meanwhile, in this embodiment, the ground coordinate system Σ_{G} is set so that the y axis is directed to a North magnetic Pole and the z axis is directed upward perpendicularly.

Also, the coordinates of the central point c_{S} is set to the initial value c_{O,0} of the offset estimation value c_{O} of the three-dimensional magnetic sensor 70 as represented by the following equation (10).

$$\begin{matrix} {q}_{0} = {B ( {μ}_{0} )}^{G} {B}_{g} + {c}_{O , 0} \\ where & ( 7 ) \\ B ( μ ) = [ \begin{matrix}{μ}_{4}^{2} + {μ}_{1}^{2} - {μ}_{2}^{2} - {μ}_{3}^{2} & 2 ( {μ}_{1} {μ}_{2} + {μ}_{4} {μ}_{3} ) & 2 ( {μ}_{1} {μ}_{3} - {μ}_{4} {μ}_{2} ) \\ 2 ( {μ}_{2} {μ}_{1} - {μ}_{4} {μ}_{3} ) & {μ}_{4}^{2} - {μ}_{1}^{2} + {μ}_{2}^{2} - {μ}_{3}^{2} & 2 ( {μ}_{2} {μ}_{3} + {μ}_{4} {μ}_{1} ) \\ 2 ( {μ}_{3} {μ}_{1} + {μ}_{4} {μ}_{2} ) & 2 ( {μ}_{3} {μ}_{2} - {μ}_{4} {μ}_{1} ) & {μ}_{4}^{2} - {μ}_{1}^{2} - {μ}_{2}^{2} + {μ}_{3}^{2}\end{matrix} ] & ( 8 ) \\ { }^{ G} {B}_{g} = [ \begin{matrix}0 \\ {r}_{0} cos {φ}_{0} \\ - {r}_{0} sin {φ}_{0}\end{matrix} ] & ( 9 ) \\ {c}_{O , 0} = {c}_{S} & ( 10 )\end{matrix}$$

On the other hand, acceleration data a₀ output from the three-dimensional acceleration sensor 80 at time T=0 is represented by the following equation (11) if the motion of the portable instrument 1 is stable (for example, if the portable instrument 1 is in a stationary state or in a uniform linear motion). Meanwhile, a vector ^{G}G_{RV} is a three-dimensional vector obtained by normalizing a vector representing the acceleration of gravity to the size of the acceleration of gravity. The vector ^{G}G_{RV} is represented by the following equation (12).

α₀=B(μ₀)^{G}G_{RV} (11)

where ^{G}G_{RV}=[0 0 −1]^{T} (12)

A vector ^{S}B_{g} indicating the direction and magnitude of the geomagnetism B_{g} in the sensor coordinate system Σ_{S} can be represented by the following equation (13a) using the magnetic data q and the offset estimation value c_{O} of the three-dimensional magnetic sensor 70.

The posture of the portable instrument 1 can be expressed as a matrix A of 3×3 represented by the following equation (13b) using the vector ^{S}B_{g} represented by the following equation (13a) and the acceleration data a. Also, it is possible to calculate the posture μ of the portable instrument 1 by re-expressing the posture of the portable instrument 1 represented by the matrix A using a quaternion. That is, an initial value μ₀ of the posture μ can be obtained based on the matrix A calculated by applying the acceleration data a₀ output from the three-dimensional acceleration sensor 80 at time T=0 and the initial value c_{O,0} of the offset estimation value c_{O} of the magnetic sensor to the following equations (13a) and (13b).

Meanwhile, conversion from the matrix A of 3×3 to the quaternion may be performed by properly using a well known method. The matrix A is a reverse matrix of the matrix B(μ) represented by equation (8). Consequently, the respective components of the matrix A may be compared with the respective components of the reverse matrix of the matrix B(μ) to calculate the respective components of the posture μ represented using the quaternion. For example, it is possible to calculate the posture μ from the matrix A using a method described in the following well known literature.

Malcolm D. Shuster and Gregory A. Natanson, “Quaternion Computation from a Geometric Point of View”, The Journal of the Astronautical Sciences, Vol. 41, No. 4, October-December 1993, pp. 545-556.

$$\begin{matrix}{ }^{S} {B}_{g} = q - {c}_{O} & ( 13 a ) \\ A = [ \begin{matrix}\frac{{[ a {\times }^{ S} {B}_{g} ]}^{T}}{‖ a {}^{ S} {B}_{g} ‖} \\ \frac{{[ ( a {}^{ S} {B}_{g} ) a ]}^{T}}{‖ ( a {}^{ S} {B}_{g} ) a ‖} \\ \frac{- {a}^{T}}{‖ a ‖}\end{matrix} ] & ( 13 b )\end{matrix}$$

The initial value r₀ of the magnitude r of the geomagnetism can be calculated based on the following equation (14a). Specifically, the initial value r₀ of the magnitude r of the geomagnetism is calculated by first substituting the magnetic data q and the initial value c_{O,0} of the offset estimation value c_{O} of the magnetic sensor into equation (13a) to obtain a vector ^{S}B_{g} and then substituting the vector ^{S}B_{g} into the following equation (14a).

Also, the initial value φ₀ of the magnetic dip φ of the geomagnetism can be calculated based on the following equation

$$\begin{matrix}r = {‖}^{ S} {B}_{g} ‖ & ( 14 a ) \\ φ = \frac{π}{2} - {cos}^{- 1} ( \frac{a {\cdot }^{S} {B}_{g}}{‖ a ‖ {‖}^{S} {B}_{g} ‖} ) & ( 14 b )\end{matrix}$$

The initial value ω₀ of the angular velocity ω is set to 0, for example, on the assumption that the portable instrument 1 is in a stationary state. Also, the initial value b_{O,0} of the offset estimation value b_{O} of the angular velocity sensor is set to 0 since the initial value is generally adjusted to be near 0.

As described above, the CPU 10 performs the initial vector generation process of step S107 to generate and output an initial vector INI, which is a vector having as its components an initial value μ₀ of the posture ρ, an initial value r₀ of the magnitude r of the geomagnetism, an initial value φ₀ of the magnetic dip φ of the geomagnetism, an initial value ω₀ of the angular velocity ω, an initial value b_{O,0} of the offset estimation value b_{O} of the angular velocity sensor, and an initial value c_{O,0} of the offset estimation value c_{O} of the magnetic sensor.

Next, at step S108, the CPU 10 performs a Kalman filter operation process. Specifically, the CPU 10 calls the Kalman filter module 600 to perform a nonlinear Kalman filter operation, thereby estimating the state of the system. That is, the CPU 10 functions as a Kalman filter operation module by performing the Kalman filter operation process of step S108.

Hereinafter, the nonlinear Kalman filter operation will be described in detail.

### 3. Operation Performed by Nonlinear Kalman Filter

Generally, a Kalman filter estimates a state vector xₖ after the lapse of unit time (at time T=k) from a state vector x⁺ₖ₋₁ indicating the state of the system at certain time (at time T=k−1) using a state transition model representing time-based change in the state of the dynamic system. This estimated value is referred to as an estimated state vector x⁻ₖ. Also, the Kalman filter estimates an observed value vector yₖ from the estimated state vector x⁻ₖ using the observation model representing a relationship between an observed value vector yₖ having outputs from various sensors as components and the state vector xₖ. This estimated value is referred to as an estimated observed value vector y⁻ₖ.

Subsequently, the Kalman filter calculates the difference (as an observation residual zₖ) between the estimated observed value vector y⁻ₖ and the observed value vector yₖ having as its components real observed values, and calculates a Kalman gain Kₖ based on the observation residual zₖ. In addition, the Kalman filter updates a state vector x⁺ₖ₋₁ using the observation residual zₖ, the Kalman gain Kₖ, and the estimated state vector x⁻ₖ to calculate a state vector x⁺ₖ after update.

The respective components of the state vector xₖ are brought close to a correct value approximate to a value (true value) correctly indicating real physical quantities through the Kalman filter operation to repeat update of the state vector xₖ as described above.

Meanwhile, in this embodiment, a sigma point Kalman filter, which is a nonlinear Kalman filter, is used as the Kalman filter, which will be described below in detail. The sigma point Kalman filter sets a plurality of sigma points χ⁺ₖ₋₁ in the vicinity of the state vector x⁺ₖ₋₁ and applies these sigma points χ⁺ₖ₋₁ to the state transition model to estimate a plurality of sigma points after the lapse of unit time. The estimated sigma points are referred to as estimated sigma points χ⁻ₖ. Subsequently, the sigma point Kalman filter calculates an average of the estimated sigma points χ⁻ₖ to obtain an estimated state vector x⁻ₖ. Strictly speaking, therefore, the estimated observed value vector yₖ is calculated based on the estimated sigma points χ⁻ₖ present in the vicinity of the estimated state vector x⁻ₖ.

In this embodiment, the state transition model of the nonlinear Kalman filter is represented by the following equation (15), and the observation model is represented by the following equation (16). Meanwhile, in this embodiment, a function ƒ present in equation (15) and a function h present in equation (16) are nonlinear functions.

xₖ=f(xₖ₋₁,k−1)+Wₖ₋₁ (15)

yₖ=h(xₖ,k)+vₖ (16)

Here, the state vector xₖ is a dim(x)-dimensional vector, and the observed value vector yₖ is a dim(y)-dimensional vector. Meanwhile, in this embodiment, dim(x)=15, and dim(y)=9. Also, a process noise wₖ present in equation (15) and an observed noise vₖ present in equation (16) are Gauss noises having 0 as the center.

Equation (15) indicates that the state vector xₖ at time T=k is estimated by adding a value obtained by substituting the state vector xₖ₋₁ at time T=k−1 into the function ƒ to a process noise wₖ₋₁ at time T=k−1.

Also, equation (16) indicates that the observed value vector yₖ at time T=k is estimated by adding a value obtained by substituting the state vector xₖ at time T=k into the function h to an observed noise vₖ at time T=k.

Meanwhile, a covariance of the process noise wₖ is denoted by Qₖ, and a covariance of the observed noise vₖ is denoted by Rk.

The observation residual zₖ at time T=k is a vector set based on the real observed value vector yₖ and the estimated observed value vector y⁻ₖ, and is represented by the following equation (17). As represented by the following equation (19), the Kalman filter calculates a state vector x⁺ₖ after update using the observation residual zₖ, the estimated state vector x⁻ₖ, and the Kalman gain Kₖ represented by equation (18). Also, the Kalman filter updates a covariance Pₖ of an estimated error of the state vector xₖ as represented by the following equation (20).

Here, P⁻ₖ is a covariance of an estimated error of the estimated state vector x⁻ₖ, and P⁺ₖ is a covariance of an estimated error of the state vector x⁺ₖ after update. Also, P^{yy}ₖ is a covariance of the observation residual zₖ, and P^{xy}ₖ is a mutual variance-covariance matrix of the estimated state vector x⁻ₖ and the estimated observed value vector y⁻ₖ.

zₖ=yₖ−h(xₖ⁻, k) (17)

Kₖ=Pₖ^{xy}(Pₖ^{yy})⁻¹ (18)

xₖ⁺=xₖ⁻+Kₖzₖ (19)

Pₖ⁺=Pₖ⁻−KₖPₖ^{yy}Kₖ^{T} (20)

Meanwhile, the estimated observed value vector y⁻ₖ is a value calculated by applying the estimated state vector x⁻ₖ (strictly speaking, the estimated sigma point χ⁻ₖ) calculated using the state transition model to the observation model as represented by equation (16). Consequently, the difference between the estimated observed value vector y⁻ₖ and the observed value vector yₖ based on real sensor outputs, i.e. the observation residual zₖ, is a value indicating a degree of approximation between the estimated state vector x⁻ₖ and a true value correctly representing real physical quantities.

As represented by equation (19), it is possible to bring the respective components of the state vector xₖ close to a value approximate to a true value by updating the estimated state vector x⁻ₖ to a state vector x⁺ₖ after update using the observation residual zₖ.

The state estimation apparatus according to this embodiment performs a Kalman filter operation process using a sigma point Kalman filter using unscented transformation.

FIG. 6 is a functional block diagram showing a function of the Kalman filter operation module realized by the CPU 10 calling the Kalman filter module 600.

As shown in FIG. 6, a delay unit 610 delays a state vector x⁺ₖ after update output from an adder 690 by unit time (time from time T=k−1 to time T=k) to generate a state vector x⁺ₖ₋₁ and outputs the generated state vector to a sigma point generation unit 620. Meanwhile, in the first operation (at time T=0), the delay unit 610 applies the initial value INI output by the initial vector generation module 500 to the state vector x⁺ₖ₋₁.

The sigma point generation unit 620 generates 2dim(x)+1 sigma points using variance-covariance matrices P⁺ₖ₋₁ and Qₖ₋₁ of dim(x) x dim(x).

Specifically, first, with respect to an average of a plurality of sigma points, a vector σₖ represented by equation (21) and equation (22) is defined using a scaling parameter λ representing degree of spread of the signal points about the average.

$$\begin{matrix} {σ}_{k} ( j ) = \sqrt{( dim ( x ) + λ ) ( {P}_{k}^{+} + {Q}_{k} )} ( j = 1 , … , dim ( x ) ) & ( 21 ) \\ {σ}_{k} ( dim ( x ) + j ) = \sqrt{( dim ( x ) + λ ) ( {P}_{k}^{+} + {Q}_{k} )} ( j = 1 , … , dim ( x ) ) & ( 22 )\end{matrix}$$

where Z satisfying ZZ^{T}=P is represented by \sqrt{P}

At this time, the sigma point generation unit 620 generates 2dim(x)+1 sigma points χₖ₋₁ represented by equation (23) and equation (24) based on a vector σₖ₋₁ and the state vector x⁺ₖ₋₁.

χₖ₋₁(0)=xₖ₋₁⁺ (23)

χₖ₋₁(j)=σₖ₋₁(j)+xₖ₋₁⁺(j=1, . . . , 2dim(x)) (24)

A state transition model unit 630 applies 2dim(x)+1 sigma points χₖ₋₁(j) at time T=k−1 to the state transition model to calculate 2dim(x)+1 estimated sigma points χ⁻ₖ(j) at time T=k as represented by equation (25).

χₖ⁻f(χₖ₋₁(j),k−1) (j=0, . . . , 2dim(x)) (25)

Subsequently, an average calculation unit 640 calculates an average value of the 2dim(x)+1 estimated sigma points χₖ⁻ at time T=k to calculate an estimated state vector x⁻ₖ as represented by equation (26).

$${x}_{k}^{-} = \frac{1}{dim ( x ) + λ} ( {λ χ}_{k}^{-} ( 0 ) + \frac{1}{2} {\sum }_{j = 1}^{2 dim ( x )} {χ}_{k}^{-} ( j ) ) \qquad ( 26 )$$

Also, the average calculation unit 640 calculates a covariance P⁻ₖ of an error of the estimated state vector x⁻ₖ represented by equation (27).

$${P}_{k}^{-} = \frac{1}{dim ( x ) + λ} ( {λ ξ}_{0} {ξ}_{0}^{T} + \frac{1}{2} {\sum }_{j = 1}^{2 dim ( x )} {ξ}_{j} {ξ}_{j}^{T} ) \qquad ( 27 )$$

where λⱼ=χₖ⁻(j)−xₖ⁻

On the other hand, an observation model unit 650 applies the 2dim(x)+1 estimated sigma points χ⁻ₖ(j) at time T=k to the observation model to calculate 2dim(x)+1 estimated observed values γₖ(j) as represented by equation (28).

γₖ(j)=h(χₖ⁻(j), k−1) (j=0, . . . , 2 dim(x)) (28)

An average processing unit 660 calculates an average of the 2dim(x)+1 estimated observed values γₖ(j) to calculate an estimated observed value vector y⁻ₖ as represented by equation (29).

$${y}_{k}^{-} = \frac{1}{dim ( x ) + λ} ( {λ γ}_{k} ( 0 ) + \frac{1}{2} {\sum }_{j = 1}^{2 dim ( x )} {γ}_{k} ( j ) ) \qquad ( 29 )$$

Subsequently, the average processing unit 660 calculates a covariance P^{yy}ₖ of an observation residual represented by equation (30).

$${P}_{k}^{y y} = \frac{1}{dim ( x ) + λ} ( {λ ζ}_{0} {ζ}_{0}^{T} + \frac{1}{2} {\sum }_{j = 1}^{2 dim ( x )} {ζ}_{j} {ζ}_{j}^{T} ) + {R}_{k} \qquad ( 30 )$$

where ζⱼ=γₖ(j)−yₖ⁻

A subtractor 670 calculates the observation residual zₖ as the difference between the observed value vector yₖ and the estimated observed value vector y⁻ₖ as represented by equation (17).

A Kalman gain apply unit 680 calculates a mutual variance-covariance matrix P^{xy}ₖ represented by equation (31). In addition, the Kalman gain apply unit 680 calculates a Kalman gain Kₖ based on the covariance P^{yy}ₖ of the residual and the mutual variance-covariance matrix P^{xy}ₖ as represented by equation (18), and executes an operation of the second term (Kₖzₖ) of the right side of equation (19). Also, the Kalman gain apply unit 680 updates the covariance Pₖ of the estimated error of the state vector xₖ from P⁻ₖ to P⁺ₖ as represented by equation (20).

$${P}_{k}^{x y} = \frac{1}{dim ( x ) + λ} ( {λ ξ}_{0} {ζ}_{0}^{T} + \frac{1}{2} {\sum }_{j = 1}^{2 dim ( x )} {ξ}_{j} {ζ}_{j}^{T} ) \qquad ( 31 )$$

The adder 690 adds the estimated state vector x⁻ₖ to the second term (Kₖzₖ) of the right side of equation (19) output from the Kalman gain apply unit 680 to calculate a state vector x⁺ₖ after update as represented by equation (19).

Hereinafter, the state transition model used in the operation of the state transition model unit 630 will be described.

In the state transition model according to this embodiment, state transition of the posture μ of the state variables constituting the state vector xₖ is defined by equation (32). Equation (32) represents an operation of estimating a posture μ⁻ₖ at time T=k after the lapse of unit time from a posture u⁺ₖ₋₁ at time T=k−1. Here, μ⁻ₖ is a component of the estimated state vector x⁻ₖ at time k corresponding to the state variable representing the posture μ.

Meanwhile, an operator Q present at the right side of equation (32) is defined by equation (33). Here, I_{3×3} represents a unit matrix of 3×3. With respect to a three-dimensional vector l=(l₁, l₂, l₃), an operator [lX] is defined by equation (34). Also, when a measurement time interval (an interval from time T=k−1 to time T=k) is denoted by Δt, and a component corresponding to the state variable representing the angular velocity of the state vector x⁺ₖ after update at time T=k is denoted by ω⁺k, a component Ψ⁺ₖ constituting the operator Q is defined by equation (35).

$$\begin{matrix}{μ}_{k}^{-} = Ω ( {ω}_{k - 1}^{+} ) {μ}_{k - 1}^{+} \\ where & ( 32 ) \\ Ω ( {ω}_{k}^{+} ) = [ \begin{matrix}cos ( \frac{1}{2} ‖ {ω}_{k}^{+} ‖ Δt ) {I}_{3 3} - [ {Ψ}_{k}^{+} \times ] & {Ψ}_{k}^{+} \\ - {{Ψ}_{k}^{+}}^{T} & cos ( \frac{1}{2} ‖ {ω}_{k}^{+} ‖ Δt )\end{matrix} ] & ( 33 ) \\ [ l \times ] = [ \begin{matrix}0 & - {l}_{3} & {l}_{2} \\ {l}_{3} & 0 & - {l}_{1} \\ - {l}_{2} & {l}_{1} & 0\end{matrix} ] & ( 34 ) \\ {Ψ}_{k}^{+} = sin ( \frac{1}{2} ‖ {ω}_{k}^{+} ‖ Δt ) \frac{{ω}_{k}^{+}}{‖ {ω}_{k}^{+} ‖} & ( 35 )\end{matrix}$$

The posture μ is expressed using a quaternion, and it is necessary to satisfy a normalization condition of =1 as represented by equation (2). In a case in which the state vector xₖ is updated using the sigma point Kalman filter, however, the state vector x⁺ₖ after update is calculated as an average of the estimated sigma points χ⁻ₖ(j) as represented by equation (26). For this reason, the norm of the state vector x⁺ₖ₋₁ (before update) and the norm of the state vector x⁺ₖ after update may be different from each other. In a case in which the sigma point Kalman filter operation is performed, therefore, the norm of the posture μ⁺ₖ₋₁, which is one component of the state vector x⁺ₖ₋₁ (before update), the norm of the posture μ⁺ₖ, which is one component of the state vector x⁺ₖ after update may be different from each other. That is, in a case in which the sigma point Kalman filter operation is performed, the normalization condition with respect to the posture μ may not be satisfied. For this reason, when any operation is performed with respect to the posture μ, the result after operation is normalized to the size of the vector. Meanwhile, in order to more strictly maintain the normalization condition, the posture μₖ, which is one of the components constituting the state vector xₖ, may be limited only to information regarding difference between the present time and the previous time using modified Rodrigues parameters (MRPs), and posture information outside the Kalman filter may be updated based on difference information obtained from the Kalman filter.

It is difficult to predict change of the magnitude r of the geomagnetism and the magnetic dip φ of the geomagnetism. For this reason, in the state transition model according to this embodiment, it is assumed that magnitude rₖ and magnetic dip φk of the geomagnetism at time T=k are equal to magnitude rₖ₋₁ and magnetic dip φₖ₋₁ of the geomagnetism at time T=k−1 for the sake of convenience.

In the same manner, it is difficult to predict change of the offset estimation value b_{O} of the angular velocity sensor. For this reason, in the state transition model according to this embodiment, it is assumed that an offset estimation value b_{O,K of the angular velocity sensor at time T=k is equal to an offset estimation value b}_{O,K-1} of the angular velocity sensor at time T=k−1 for the sake of convenience.

Since the angular velocity ω of the portable instrument 1 is changed depending upon the movement of the portable instrument 1 caused by a user of the portable instrument 1, it is difficult to formalize angular velocity ωₖ at time T=k using angular velocity ωₖ₋₁ at time T=k−1. For this reason, in the state transition model according to this embodiment, it is assumed that the angular velocity ωₖ at time T=k is equal to the angular velocity ωₖ₋₁ at time T=k−1 for the sake of convenience.

As previously described, the offset c_{OFF} of the magnetic sensor is a vector expressing the direction and magnitude of the internal magnetic field Bᵢ generated by the part of the portable instrument 1 in the sensor coordinate system Σ_{S}. In a case in which the internal state of the portable instrument 1 is uniform, therefore, the offset C_{OFF} of the magnetic sensor is also not changed. On the other hand, in a case in which the internal state of the portable instrument 1 is changed, for example, in a case in which the magnitude of current flowing in the part mounted in the portable instrument 1 is changed or in a case in which the magnetized state of the part mounted in the portable instrument 1 is changed, the offset C_{OFF} of the magnetic sensor is also changed. That is, the internal state of the portable instrument 1 is changed depending upon user manipulation of the portable instrument 1 and external environment of the portable instrument 1. Consequently, it is difficult to predict the timing when the offset c_{OFF} of the magnetic sensor is changed and the change amount of the offset c_{OFF} of the magnetic sensor, and it is difficult to formalize an offset estimation value c_{O,K} of the magnetic sensor at time T=k using an offset estimation value c_{O,K-1} of the magnetic sensor at time T=k−1.

For this reason, in the state transition model according to this embodiment, it is assumed that the offset estimation value c_{O,K} of the magnetic sensor at time T=k is equal to the offset estimation value c_{O,K-1} of the magnetic sensor at time T=k−1 for the sake of convenience.

In this way, in the state transition model according to this embodiment, it is premised that the remaining portions of the state variables constituting the state vector xₖ except the state variable representing the posture μ are not changed from the previous time as represented by the following equation (36).

$$[ \begin{matrix}{r}_{k} \\ {φ}_{k} \\ {ω}_{k} \\ {b}_{O , k} \\ {c}_{O , k}\end{matrix} ] = [ \begin{matrix}{r}_{k - 1} \\ {φ}_{k - 1} \\ {ω}_{k - 1} \\ {b}_{O , k - 1} \\ {c}_{O , k - 1}\end{matrix} ] \qquad ( 36 )$$

Meanwhile, in the Kalman filter operation, the state vector xₖ is updated based on the observation residual zₖ. Consequently, all of the values indicated in equation (36) except the posture μ are changed. Specifically, the respective components of the state vector xₖ are updated so as to approximate to a true value based on the observation residual zₖ by the adder 690.

Next, the observation model used in the operation performed by the observation model unit 650 will be described.

An estimated value γ_{gyro} of the angular velocity data g output from the three-dimensional angular velocity sensor 90 is represented by equation (37) using the angular velocity ω and the offset estimation value b_{O} of the angular velocity sensor.

γ_{gyro}=ω+b_{O} (37)

Also, in the observation model, the vector ^{G}B_{g} representing the geomagnetism B_{g} in the ground coordinate system Σ_{G} is represented by equation (38). Consequently, an estimated value γ_{mag} of the magnetic data q output from the three-dimensional magnetic sensor 70 is represented by equation (39) using the offset estimation value c_{O} of the magnetic sensor and the matrix B(μ) represented by equation (8).

$$\begin{matrix}{ }^{G} {B}_{g} = [ \begin{matrix}0 \\ r cos φ \\ - r sin φ\end{matrix} ] & ( 38 ) \\ {Y}_{mag} = B ( μ ) [ \begin{matrix}0 \\ r cos φ \\ - r sin φ\end{matrix} ] + {c}_{O} & ( 39 )\end{matrix}$$

Also, in the observation model, an estimated value γ_{acc} of the acceleration data a output from the three-dimensional acceleration sensor 80 is represented by equation (40) using the matrix B(μ) represented by equation (8) and the vector ^{G}G_{RV} represented by equation (12)

γ_{acc}=B(μ)^{G}G_{RV} (40)

It is possible to modify equation (17) to the following equation (41) by substituting equation (3) into the first term of the right side of equation (17) and representing the second term of the right side of equation (17) using equation (37), equation (39), and equation (40). At this time, the observation residual zₖ is calculated by equation (41).

$${z}_{k} = [ \begin{matrix}{q}_{k} \\ {a}_{k} \\ {g}_{k}\end{matrix} ] - [ \begin{matrix}{Y}_{mag} \\ {Y}_{acc} \\ {Y}_{gyro}\end{matrix} ] \qquad ( 41 )$$

### 4. Conclusion

As described above, the CPU 10 calls the Kalman filter module 600 to perform the Kalman filter operation process of step S108, thereby updating the state vector xₖ. Specifically, the state vector xₖ at time T=k is calculated by updating the state vector xₖ₋₁ at time T=k−1 based on the observation residual zₖ calculated using the state vector xₖ₋₁. In the same manner, the state vector xₖ₋₁ at time T=k−1 is calculated by updating the state vector xₖ₋₂ at time T=k−2 based on the observation residual zₖ₋₁ calculated using the state vector xₖ₋₂. That is, in the Kalman filter operation process, the state vector xₖ is updated in consideration of values of all state vectors x₀ to xₖ₋₁ ranging from the initial state (time T=0) to time T=k−1. In a case in which the respective components of the initial vector INI are set to values greatly deviating from true values, therefore, the respective components of the state vector xₖ may not approximate to the true value although the Kalman filter operation is performed. Also, even if the respective components of the state vector xₖ approximate to the true value, it takes a long time until the respective components of the state vector xₖ converge to values approximate to the true value.

As previously described, the offset c_{OFF} of the magnetic sensor is a vector representing the internal magnetic field Bᵢ generated by the part of the portable instrument 1. In a case in which a great internal magnetic field Bᵢ is generated by the part mounted in the portable instrument 1, therefore, the initial value c_{O,0} of the offset estimation value c_{O} of the magnetic sensor may greatly deviate from the offset c_{OFF} of the magnetic sensor if a predetermined fixed value (for example, the origin [0, 0, 0,]^{T}) is applied to the initial value c_{O,0} of the offset estimation value c_{O} of the magnetic sensor. Also, in a case in which a predetermined fixed value is set to the initial value μ₀ of the posture μ, the posture deviates from the real posture by a maximum of 180 degrees. Thus, the initial value c_{O,0} of the offset estimation value c_{O} of the magnetic sensor and the initial value μ₀ of the posture μ, which are some of the components constituting the initial vector INI, may greatly deviate from the true value.

In order to prevent the respective components of the initial vector INI from being set to improper values (values deviating from the true value), therefore, it is particularly important to set the initial value c_{O,0} of the offset estimation value c_{O} of the magnetic sensor and the initial value μ₀ of the posture μ to correct values approximate to the true value.

In this embodiment, first, the coordinates of the central point c_{S}, which is a value approximate to the offset c_{OFF}, are calculated through the central point calculation process, and then the coordinates of the central point c_{S} are applied to the initial value c_{O,0} of the offset estimation value c_{O} of the magnetic sensor to calculate the initial vector INI through the initial vector generation process. As a result, the initial value c_{O,0} of the offset estimation value c_{O} of the magnetic sensor is prevented from being set to a value greatly deviating from the true value.

Also, in this embodiment, it is decided through the stability decision process whether the motion of the portable instrument 1 is stable, and then the initial value μ₀ of the posture μ is calculated. Consequently, the initial value μ₀ of the posture μ is prevented from being set to a value greatly deviating from the true value.

In this embodiment as described above, the respective components of the initial vector INI are set to correct values approximate to the true value, and therefore, correct and rapid state estimation is possible in the Kalman filter operation process.

### B. Modifications

The present invention is not limited to the above-described embodiments but may be modified as follows. Also, two or more of the following modifications can be combined.

### (1) First modification

Although, in the above-described embodiments, the stability index α is calculated based on the reference acceleration data a_{C} calculated using the low pass filter and the acceleration data a through the stability decision process, the present invention is not limited thereto. The stability index a may be calculated without using the low pass filter.

For example, a stability index β represented by the following equation (43) may be used to decide whether the motion of the portable instrument 1 is stable or not based on a condition represented by the following equation (42).

Here, the stability index β is a value representing a variance of a plurality of acceleration data a₁ to a_{M} output from the three-dimensional acceleration sensor 80 during a period from time t=1 to time t=M as represented by the following equation (43). Also, in a case in which the stability index β is a sufficiently small value equal to or less than a second threshold value β_{TH} as represented by equation (42), the motion of the portable instrument 1 can be regarded as being stable since change of the values indicated by the acceleration data a₁ to a_{M} is small (M being an integer indicating a prescribed number of times for measuring acceleration data necessary to calculate the variance of the acceleration data a).

Meanwhile, values a_{x,AVE}, a_{y,AVE}, and a_{z,AVE} present in equation (43) are average values of the respective components of the acceleration data a₁ to a_{M}, and are represented by equation (44), equation (45), and equation (46), respectively.

$$\begin{matrix}β ≦ {β}_{T H} & ( 42 ) \\ β = \frac{1}{M} {\sum }_{t = 1}^{M} \{ {( {a}_{x t} - {a}_{x , A V E} )}^{2} + {( {a}_{y t} - {a}_{y , A V E} )}^{2} + {( {a}_{z t} - {a}_{z , A V E} )}^{2} \} & ( 43 ) \\ {a}_{x , A V E} = \frac{1}{M} {\sum }_{t = 1}^{M} {a}_{x t} & ( 44 ) \\ {a}_{y , A V E} = \frac{1}{M} {\sum }_{t = 1}^{M} {a}_{y t} & ( 45 ) \\ {a}_{z , A V E} = \frac{1}{M} {\sum }_{t = 1}^{M} {a}_{z t} & ( 46 )\end{matrix}$$

### (2) Second modification

Although, in the state estimation apparatus according to the embodiments and the modifications as described above, the CPU 10 performs the respective processes of steps S101 to S108, the present invention is not limited thereto. The CPU 10 may perform only some processes of steps S101 to S108.

For example, the state estimation apparatus may not include the second notification part, and therefore, the CPU 10 may not perform the second notification of step S105.

It is difficult to assume that the portable instrument 1 is moved continuously for a long period of time, and the portable instrument 1 is generally in a stable state. Also, it is confirmed that the portable instrument 1 is stable through the stability decision process of step S106, and then the initial vector INI is calculated. Consequently, it is possible to prevent the initial value μ₀ of the posture μ from being set to a value greatly deviating from the true value although the state estimation program 100 does not include the second notification part.

Also, for example, the state estimation apparatus may not include the first notification part, and therefore, the CPU 10 may not perform the first notification of step S102. In this case, the CPU 10 may decide whether a plurality of accumulated magnetic data q₁ to q_{N} is proper to calculate the central point c_{S} of the spherical surface S through the magnetic data accumulation process of step S103, and, in a case in which it is decided that the accumulated magnetic data are proper, CPU 10 may advance the process to step S104. Specifically, the CPU 10 may decide whether the respective magnetic data q₁ to q_{N} are broadly distributed so that the coordinates indicated by the magnetic data q₁ to q_{N} in the sensor coordinate system Σ_{S} have three-dimensional spread through the magnetic data accumulation process of step S103, and, in a case in which it is decided that the coordinates indicated by the magnetic data have three-dimensional spread, CPU 10 may advance the process to step S104.

Also, for example, the state estimation apparatus may not include either of the first notification part and the second notification part, and therefore, the CPU 10 may not perform the first notification of step S102 and the second notification of step S105.

### (3) Third Modification

Although, in the state estimation apparatus according to the embodiments and the modifications as described above, the CPU 10 performs the Kalman filter operation process using the sigma point Kalman filter, the present invention is not limited thereto. A well known nonlinear Kalman filter may properly be used to perform the operation. For example, the Kalman filter operation process may be performed using an extended Kalman filter.

### (4) Fourth Modification

In the state estimation apparatus according to the disclosed embodiments and modifications, the stability decision module 400 decides whether the motion of the portable instrument 1 is stable or not based on a plurality of acceleration data a. However, the present invention is not limited to the disclosed embodiments and modifications. The stability decision module may utilize other devices for deciding whether the motion of the portable instrument 1 is stable or not. For example, in case that the instrument 1 is provided with a camera having a a shutter device and an image capture device, the stability decision module analyzes a field image captured by the image capture device while the shutter device is held open, and decides whether the motion of the portable instrument 1 is stable or not based on results of analysis of the captured field image. In cased that the results of the analysis indicate that the captured field image is stationary, the stability decision device decides that the portable instrument 1 is stable.

### (5) Fifth Modification

The state estimation apparatus according to the disclosed embodiments and modifications is provided with the RAM 20 for accumulating magnetic data q successively output from the three dimensional magnetic sensor 70, and the central point calculation module 300 for calculating three axis coordinates of a central point c_{S} indicating an approximate value of an offset c_{OFF} representing a magnetic field generated by the part mounted in the instrument 1. The initial vector generation module 500 obtains an estimated value c_{O} of the offset c_{OFF} of the three dimensional magnetic sensor representing the magnetic field generated by the part based on the calculated three axis coordinates of the central point cₛ. However, the present invention is not limited to the disclosed embodiments and modifications. The estimated value c_{O} of the offset c_{OFF} can be obtained by other means. For example, In case that the instrument 1 is judged to be stable, the state estimation apparatus may access a memory such as ROM 30 or RAM 20 mounted in the instrument 1, then read out from the memory a default value or typical value of the three axis coordinates of the central point c_{S}, and may obtain the estimated value c_{O} of the offset c_{OFF} based on the read default value or typical value. Otherwise, a past value of the three axis coordinates of the central point c_{S} is previously stored in the memory. Then, in case that the motion of the instrument 1 is judged to be stable, the state estimation apparatus accesses the memory, then reads out from the memory the past value of the three axis coordinates of the central point c_{S}, and obtains the estimated value c_{O} of the offset c_{OFF} based on the read past value. Otherwise, there may be provided an external device capable of transmitting data to the portable instrument and receiving data from the portable instrument 1 by wireless or wired communication. The external device may be equipped with a part of functions (such as offset estimation function) of the central point calculation module 300 and initial vector generation module 500.

### (6) Sixth Modification

In the state estimation apparatus according to the disclosed embodiments and modifications, the initial vector generation module 500 generates the initial vector including as its components a vector estimating posture μ of the instrument 1 based on the three axis coordinates of the central point cₛ, magnetic data q and acceleration data a. However, the present invention is not limited to the disclosed embodiments and modifications. The vector estimating the posture μ can be obtained by other means. For example, a dedicated stationary deck is provided for the portable instrument, and the stationary deck is oriented to north direction and held horizontally pursuant to guide of the portable instrument. In such a case, when the portable instrument is placed into the stationary deck, the portable instrument detects that the portable instrument is placed into the stationary deck by means of a contact switch mounted on the portable instrument, and judges that the motion of the portable instrument is stable and that the posture of the portable instrument is held horizontal and oriented to the north direction. By this decision, the initial vector generation module 500 estimates the posture μ of the portable instrument as being horizontal and north-oriented based on the result of the detection by the internal contact switch. In such a case, in place of the initial vector generation module 500, an initial vector retrieval module may be provided in the portable instrument for retrieving an initial vector which may be stored in ROM 30 in corresponding to a detection result of the contact switch or which may be stored in a memory region of the stationary deck.

What is claimed is:

1. A state estimation apparatus mounted in an instrument comprising a part generating a magnetic field, the state estimation apparatus comprising:
a three-dimensional magnetic sensor that detects magnetic components in three directions perpendicular to each other and sequentially outputs magnetic data as three-dimensional vector data expressed in a three axis coordinate system;
a three-dimensional acceleration sensor that detects acceleration at three axes perpendicular to each other and sequentially outputs acceleration data as three-dimensional vector data expressed in a three axis coordinate system;
a stability decision module that decides whether motion of the instrument is stable or not; and
a Kalman filter operation module that sets an initial vector to a state vector of Kalman filter as an initial value thereof in case that the stability decision module decides that the motion of the instrument is stable, and then updates the state vector of Kalman filter using an observed value vector having outputs of a plurality of sensors being mounted in the instrument and including the three-dimensional magnetic sensor and the three-dimensional acceleration sensor, the initial vector having as components thereof an estimated value of an offset representing the magnetic field generated by the part of the instrument and a vector estimating a posture of the instrument.

2. The state estimation apparatus according to claim 1, further comprising an initial vector generation module that generates the initial vector in case that the stability decision module decides that the motion of the instrument is stable.

3. The state estimation apparatus according to claim 2, wherein the initial vector generation module generates the initial vector based on the magnetic data, the acceleration data, and three axis coordinates of a central point of a plurality of magnetic data, the central point indicating an approximate value of the offset of the three-dimensional magnetic sensor.

4. The state estimation apparatus according to claim 3, further comprising:
an accumulation module that accumulates the magnetic data sequentially output from the three-dimensional magnetic sensor; and
a central point calculation module that calculates the three axis coordinates of the central point based on the plurality of magnetic data accumulated in the accumulation module.

5. The state estimation apparatus according to claim 4, further comprising a first notification part that urges a user to change the posture of the instrument before the central point calculation module starts to acquire the plurality of magnetic data used to calculate the central point.

6. The state estimation apparatus according to claim 5, further comprising a second notification part for urging the user not to change the posture of the instrument after the central point calculation module calculates the central point.

7. The state estimation apparatus according to claim 1, wherein the stability decision module decides whether the motion of the instrument is stable or not based on the plurality of acceleration data output from the three dimensional acceleration sensor.

8. The state estimation apparatus according to claim 7, wherein the stability decision module comprises a low pass filter for calculating reference acceleration data based on the plurality of acceleration data, calculates stability indices representing errors between three axis coordinates indicated by the acceleration data and three axis coordinates indicated by the reference acceleration data with respect to a predetermined number of the acceleration data, and decides that the motion of the instrument is stable in case that all of the stability indices are equal to or less than a first threshold value.

9. The state estimation apparatus according to claim 7, wherein the stability decision module calculates a variance of the three axis coordinates indicated by a predetermined number of the acceleration data as a stability index, and decides that the motion of the instrument is stable in case that the stability index is equal to or less than a second threshold value.

10. A control method of a state estimation apparatus mounted in an instrument comprising a part generating a magnetic field, the state estimation apparatus including a three-dimensional magnetic sensor that detects magnetic components in three directions perpendicular to each other and sequentially outputs magnetic data as three-dimensional vector data expressed in a three axis coordinate system, and a three-dimensional acceleration sensor that detects acceleration at three axes perpendicular to each other and sequentially outputs acceleration data as three-dimensional vector data expressed in a three axis coordinate system, the control method comprising:
a stability decision step of deciding whether motion of the instrument is stable or not; and
a Kalman filter operation step of setting an initial vector to a state vector of Kalman filter as an initial value thereof in case that the stability decision step decides that the motion of the instrument is stable, and then updating the state vector of Kalman filter using an observed value vector having outputs of a plurality of sensors being mounted in the instrument and including the three-dimensional magnetic sensor and the three-dimensional acceleration sensor, the initial vector having as components thereof an estimated value of an offset representing the magnetic field generated by the part of the instrument and a vector estimating a posture of the instrument.
